(19) United States
(12) Patent Application Publication
(10) Pub. No.: US 2013/0048034 A1
(43) Pub. Date: Feb. 28, 2013

(54) SUBSTRATE TREATING APPARATUS

(71) Applicant: Tadashi MAEGAWA, Kyoto-shi (JP)

(72) Inventor: Tadashi MAEGAWA, Kyoto-shi (JP)

(21) Appl. No.: 13/584,279

(22) Filed: Aug. 13, 2012

(30) Foreign Application Priority Data
Aug. 25, 2011 (JP) 2011-183696

(51) Int. Cl. B08B 3/04

(52) U.S. Cl. 134/104.2

(57) ABSTRACT

A substrate treating apparatus for immersing substrates in a treating liquid. An inner tank stores the treating liquid, an outer tank collects the treating liquid overflowing the inner tank, and a lifter moves the substrates between a standby position above the inner tank and a treating position inside the inner tank. Circulation piping connects the inner tank and the outer tank. The treating liquid overflows the inner tank into the outer tank in a treating state with the lifter and the substrates located in the treating position. The treating liquid remains in the inner tank without overflowing in a non-treating state with the lifter and the substrates located in the standby position. The treating liquid flows from the inner tank to the outer tank through the circulating piping in a non-treating circulation state before the lifter moves the substrates to the treating position.

### BACKGROUND OF THE INVENTION

(1) Field of the Invention

This invention relates to a substrate treating apparatus for treating, with a treating liquid, substrates such as semiconductor wafers, glass substrates for liquid crystal displays, substrates for plasma displays, substrates for organic EL, substrates for FEDs (Field Emission Displays), substrates for optical displays, substrates for magnetic disks, substrates for photomasks, and substrates for solar cells (hereinafter called simply “substrates”). More particularly, the invention relates to a technique for immersing and treating the substrates in the treating liquid stored in an inner tank.

(2) Description of the Related Art

Conventionally, this type of apparatus includes a treating tank having an inner tank for storing a treating liquid and receiving substrates and an outer tank for collecting the treating liquid overflowing the inner tank, circulation piping for interconnecting the inner tank and outer tank for mutual communication, a pump for feeding under pressure the treating liquid from the outer tank to the inner tank through the circulation piping, and a heater for heating the treating liquid flowing through the circulation piping. See FIG. 1 of Japanese Patent No. 3948912, for example.

The apparatus having the above construction feeds the treating liquid into the inner tank, and adjusts the treating liquid to a treatment temperature with the heater while circulating with the pump the treating liquid having overflowed to the outer tank. After the temperature of the treating liquid reaches the treatment temperature, a lifter supporting a plurality of (e.g. 25) substrates in a vertical posture is lowered from a standby position above the inner tank to a treating position in the treating liquid inside the inner tank. By maintaining this state for a treatment time, a predetermined treatment with the treating liquid is carried out for the substrates.

The conventional apparatus noted above has the following drawback.

When the conventional apparatus carries out temperature control of the treating liquid, it is necessary to supply the treating liquid in enough quantity to overflow the inner tank to the outer tank so that the treating liquid can be circulated by the pump in a state of the substrates and the lifter not being immersed in the inner tank. When the lifter is immersed along with the substrates in the treating liquid inside the inner tank, the treating liquid will overflow to the outer tank in a quantity corresponding to the volume of the lifter and the substrates. The outer tank is constructed to hold this quantity. That is, at the time of temperature control of the treating liquid before treatment of the substrates, the treating liquid is circulated in a quantity substantially exceeding what is necessary for treatment. This poses a problem of the treating liquid being used in an increased quantity.

### SUMMARY OF THE INVENTION

This invention has been made having regard to the state of the art noted above, and its object is to provide a substrate treating apparatus which can reduce the quantity of a treating liquid used, by employing a is construction for circulating the treating liquid in a minimum quantity required for treatment.

The above object is fulfilled, according to this invention, by a substrate treating apparatus for treating substrates by immersing the substrates in a treating liquid, comprising an inner tank for storing the treating liquid, an outer tank for collecting the treating liquid overflowing the inner tank, a lifter movable with the substrates between a standby position above the inner tank and a treating position inside the inner tank, circulation piping connected to the inner tank and the outer tank for circulating the treating liquid, and a circulation control device for storing the treating liquid in the inner tank, the outer tank, and the circulation piping, in such a quantity that the treating liquid overflows the inner tank into the outer tank in a treating state in which the lifter with the substrates is located in the treating position, and remains in the inner tank without overflowing into the outer tank in a non-treating state in which the lifter with the substrates is located in the standby position, and for causing the treating liquid to flow from the inner tank to the outer tank and circulate through the circulating piping in a non-treating circulation state before the lifter moves with the substrates to the treating position.

According to this invention, the treating liquid is stored in the inner tank, outer tank, and circulation piping in such a quantity that the treating liquid overflows the inner tank into the outer tank in the treating state, but does not overflow the inner tank into the outer tank in the non-treating state. On the other hand, in the non-treating circulation sate, the circulation control device causes the treating liquid to flow from the inner tank to the outer tank and circulate through the circulation piping. Therefore, the treating liquid can be circulated even in the state where the lifter with the substrates is not in the treating position, thereby to reduce the quantity of treating liquid used in treatment. As a result, an operation for temperature control or adjustment of chemical concentration can be carried out in a short time.

The substrate treating apparatus may further comprise a switch valve disposed on a side wall of the inner tank, in a height position below an upper edge of the side wall of the inner tank; wherein the circulation control device is arranged to open the switch valve in the non-treating circulation state, and close the switch valve in the treating state.

When the circulation control device opens the switch valve in the non-treating circulation state, the treating liquid will flow from a height position below the upper edge of the side wall of the inner tank out into the outer tank. Thus, even in the state where the lifter with the substrates is not in the treating position, the treating liquid can be circulated by the simple operation to open the switch valve.

In this invention, the switch valve may be disposed at a liquid level in the inner tank occurring when a change is made from the treating state to the non-treating state.

With the switch valve disposed at a liquid level in the inner tank occurring when a change is made to the non-treating state, the apparatus can circulate a minimum quantity of treating liquid required for treatment.

In this invention, the switch valve may have a piston retractable at an opening time, and projectable at a closing time, the piston having a forward end thereof projectable to a position flush with an inner wall surface of the inner tank at the closing time.

Switching can be made between the treating state and the non-treating circulation state by projecting and retracting the piston. Further, since the forward end of the piston is flush with the inner wall surface of the inner tank in the treating state, it does not disturb flows of the treating liquid in the inner tank in the treating state.

In this invention, the inner tank may have an upper inner tank including an upper edge, and a lower inner tank including a bottom; the apparatus further comprising a lift device for vertically moving one of the upper inner tank and the lower inner tank; wherein the circulation control device is arranged to operate the lift device to form a gap between the upper inner tank and the lower inner tank in the non-treating circulation state, and to place the upper inner tank and the lower inner tank in close contact with each other in the treating state.

The inner tank has a split construction including the upper inner tank and lower inner tank, and the treating liquid can be made to flow out over the upper edge of the lower inner tank by operating the lift device to form a gap between the upper inner tank and lower inner tank. Since the treating liquid can be made to flow out over the entire circumference of the upper edge of the lower inner tank, the treating liquid in the inner tank can flow out uniformly. As a result, the temperature control and concentration adjustment of the treating liquid can be carried out with less unevenness, and in a reduced time.

The substrate treating apparatus may further comprise auto covers arranged above the inner tank and the outer tank to be closed in the non-treating circulation state, and opened and closed when a change is made from the non-treating state to the treating state; and elastic members attached to lower surfaces of the auto covers to be extendible into the treating liquid in the inner tank, and contractible upward above the treating liquid in the inner tank; wherein the circulation control device is arranged to extend the elastic members in the non-treating circulation state, and contract the elastic members in the treating state.

The elastic members of the auto covers are extended in the non-treating circulation state. This pushes up the treating liquid level in the inner tank, thereby causing the treating liquid to flow from the inner tank to the outer tank. Thus, only by extending the elastic members, the treating liquid can be circulated.

The substrate treating apparatus may further comprise an elastic member disposed in a bottom of the inner tank to be extendible toward a surface of the treating liquid in the inner tank, and contractible to the bottom; wherein the circulation control device is arranged to extend the elastic member in the non-treating circulation state, and contract the elastic member in the treating state.

The elastic member in the bottom of the inner tank is extended in the non-treating circulation state. This pushes up the treating liquid level in the inner tank, thereby causing the treating liquid to flow from the inner tank to the outer tank. Thus, only by extending the elastic member, the treating liquid can be circulated.

The substrate treating apparatus may further comprise a dummy block movable into and out of the inner tank; wherein the circulation control device is arranged to move the dummy block into the inner tank in the non-treating circulation state, and move the dummy block out of the inner tank in the treating state.

The treating liquid level in the inner tank can be raised when the dummy block is moved into the inner tank in the non-treating circulation state. Thus, only by moving the dummy block, the treating liquid can be circulated.

The substrate treating apparatus may further comprise a bubble feeding device for feeding bubbles into the inner tank; wherein the circulation control device is arranged to cause the bubble feeding device to feed bubbles in the non-treating circulation state, and stop the bubble feeding device feeding the bubbles in the treating state.

By feeding bubbles from the bubble feeding device, the treating liquid level in the inner tank can be pushed up in response to the quantity of bubbles. Thus, only by generating bubbles, the treating liquid can be circulated. Since variations of the liquid level caused by bubbles are small, this feature may be combined, for example, with a mode of pushing up the liquid level to a considerable degree, for effective use in fine adjustment of the liquid level.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is an overall view showing an outline of a substrate treating apparatus in Embodiment 1;

FIG. 2 is a view showing substrates in a treating position;

FIG. 3 is a view showing the substrates in a standby position;

FIG. 4 is a view showing details of a switch valve;

FIG. 5 is an explanatory view of a non-treating circulation state;

FIG. 6 is an explanatory view of a treating state;

FIG. 7 is an overall view showing an outline of a substrate treating apparatus in Embodiment 2;

FIG. 8 is an explanatory view of a non-treating circulation state;

FIG. 9 is an explanatory view of a treating state;

FIG. 10 is an overall view showing an outline of a substrate treating apparatus in Embodiment 3;

FIG. 11 is an explanatory view of a non-treating circulation state;

FIG. 12 is an explanatory view of a treating state;

FIG. 13 is an overall view showing an outline of a substrate treating apparatus in Embodiment 4;

FIG. 14 is an explanatory view of a non-treating circulation state;

FIG. 15 is an explanatory view of a treating state;

FIG. 16 is an overall view showing an outline of a substrate treating apparatus in Embodiment 5; and

FIG. 17 is an overall view showing an outline of a substrate treating apparatus in Embodiment 6.

### DESCRIPTION OF THE PREFERRED EMBODIMENTS

Various embodiments of the substrate treating apparatus according to this invention will be described hereinafter with reference to the drawings.

### Embodiment 1

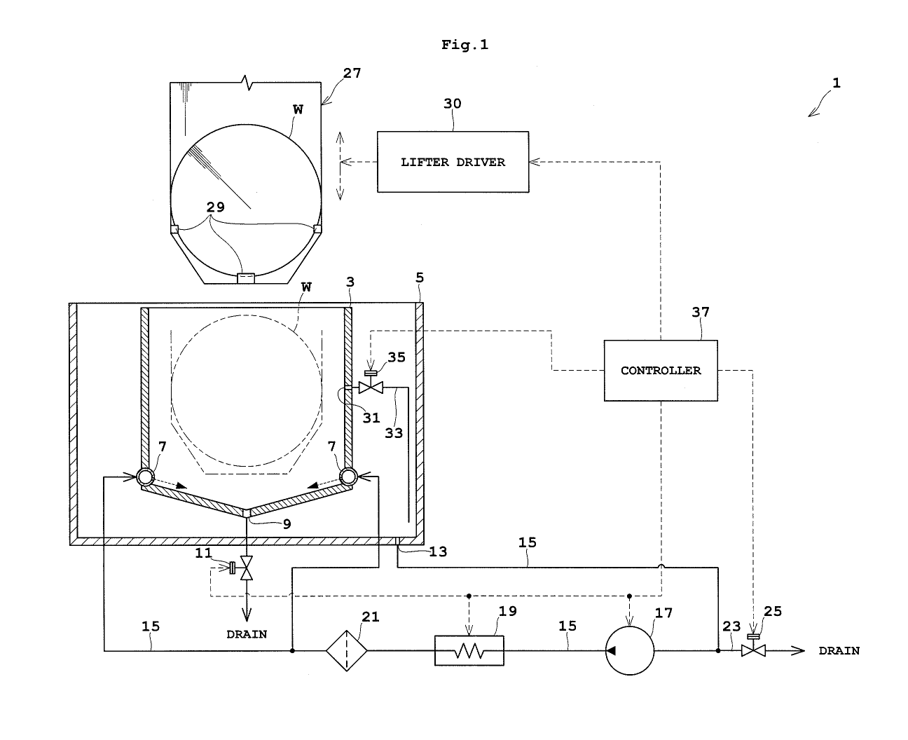

FIG. 1 is an overall view showing an outline of a substrate treating apparatus in Embodiment 1.

This substrate treating apparatus 1 treats a is plurality of wafers W in batches with a treating liquid. One batch consists of 50 wafers W, for example. The substrate treating apparatus 1 includes an inner tank 3 and an outer tank 5. The inner tank 3 stores the treating liquid and receives the wafers W. The outer tank 5 surrounds the inner tank 3 for collecting the treating liquid overflowing the inner tank 3. The inner tank 3 has an opening at the top and filling pipes 7 arranged at opposite sides of the bottom. A drain port 9 is formed centrally of the bottom. A quick drain valve 11 is attached to the drain port 9 for draining the treating liquid from the inner tank 3 at a rapid rate.

A drain port 13 is formed in the bottom of the outer tank 5. One end of circulation piping 15 is connected to this drain port 13, while the other end of the circulation piping 15 is connected to the filling pipes 7. The circulation piping 15 has a circulating pump 17, an in-line heater 19, and a filter 21 arranged in order from adjacent the drain port 13. The circulating pump 17 feeds the treating liquid under pressure through the circulation piping 15. The in-line heater 19 carries out temperature control of the treating liquid flowing through the circulation piping 15. The temperature control is carried out targeting a treatment temperature set for each treatment. The filter 21 removes particles included in the treating liquid.

A waste liquid pipe 23 is connected to the circulation piping 15 upstream of the circulating pump 17. The waste liquid pipe 23 has a switch valve 25 mounted thereon. The waste liquid pipe 23 discharges the treating liquid remaining in the outer tank 5 and circulation piping 15.

A lifter 27 is disposed above the inner tank 3. The lifter 27 has supports 29 provided in lower positions thereof for contacting and supporting lower edges of the wafers W. The lifter 27 is constructed vertically movable between a “standby position” above the inner tank 3 as shown in solid lines in FIG. 1 and a “treating position” inside the inner tank 3 as shown in two-dot chain lines. The vertical movement of the lifter 27 is controlled by a lifter driver 30.

The inner tank 3 has a circulation port 31 formed in one side wall thereof. One end of a circulation flow pipe 33 is connected to the circulation port 31. The other end of the circulation flow pipe 33 extends toward the bottom of the outer tank 5. The circulation flow pipe 33 has a switch valve 35 mounted thereon. The height position in which the circulation port 31 is formed will be described in detail hereinafter.

The quick drain valve 11, pump 17, in-line heater 19, lifter driver 30, switch valve 25, and switch valve 35 noted above are all controlled by a controller 37. The controller 37 has a CPU and memory built therein for controlling the various components based on prestored operation control programs and recipes specifying treatment.

The above controller 37 corresponds to the “circulation control device” in this invention.

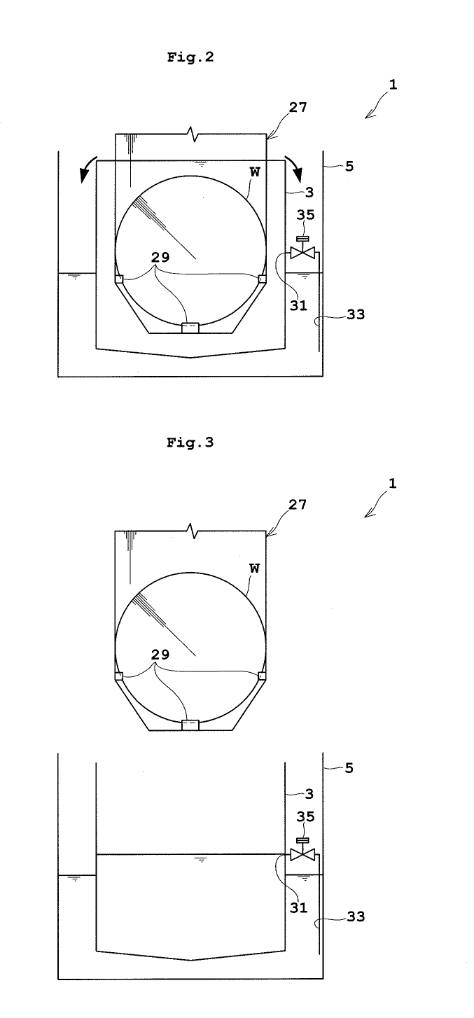

An arranging position in the inner tank 3 of the above-noted circulation port 31, circulation flow pipe 33, and switch valve 35 will be described with reference to FIGS. 2 and 3. FIG. 2 is a view showing the wafers W in the treating position. FIG. 3 is a view showing the wafers W in the standby position.

FIG. 2 shows a treating state in which the lifter 27 has moved along with the wafers W to the treating position.

In this treating state, the treating liquid level in the inner tank 3 rises by an amount corresponding to a total of the volume of the lifter 27 located in the inner tank 3, the volume of the supports 29, and the volume of the wafers W, whereby the treating liquid flows over the entire upper edge of the inner tank 3 into the outer tank 5. FIG. 3 shows a non-treating state in which the lifter 27 has moved along with the wafers W to the standby position. In this non-treating state, the treating liquid level in the inner tank 3 lowers so that the treating liquid will not flow over the upper edge of the inner tank 3 into the outer tank 5. The circulation port 31, circulation flow pipe 33, and switch valve 35 are arranged in the height position of the treating liquid level in the inner tank 3 when a change has been made from the treating state to the non-treating state.

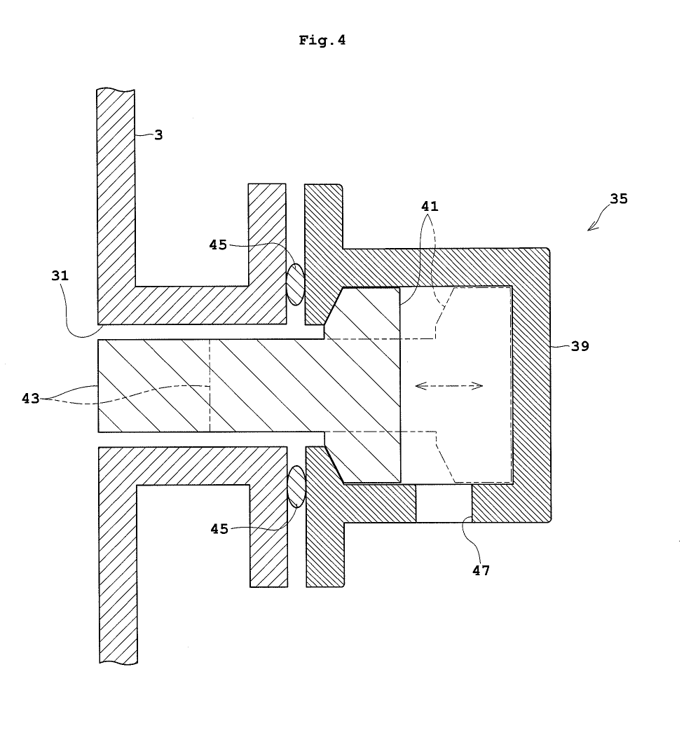

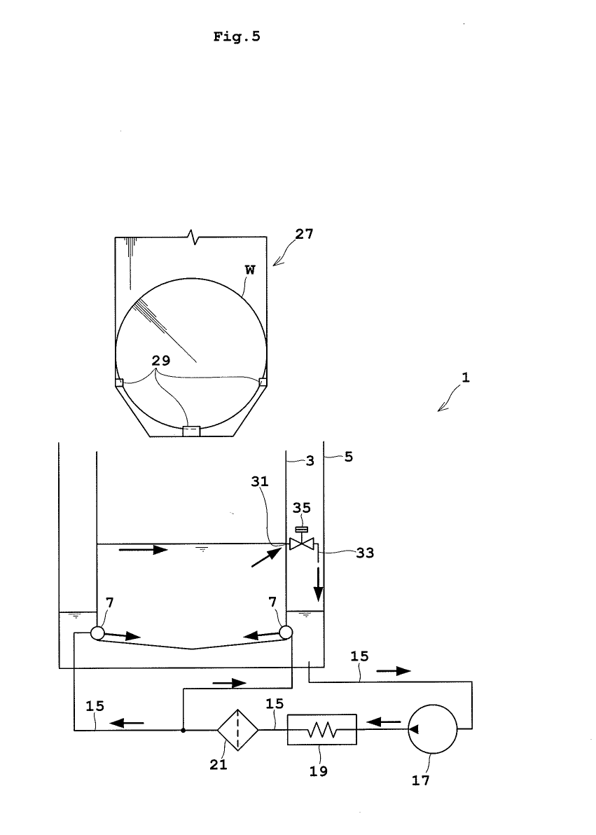

Next, a preferred construction of the above switch valve 35 will be described with reference to FIG. 4. FIG. 4 is a view in vertical section showing details of the switch valve.

The switch valve 35 is disposed in the above-noted height position on the side wall of the inner tank 3. A housing 39 covers a piston 41 from the side of the inner tank 3. The housing 39 is attached to the inner tank 3 such that the piston 41 has a forward end 43 thereof projectable to a position flush with an inner surface of the side wall of the inner tank 3. The housing 39 is attached to the side wall of the inner tank 3 through an O-ring 45. An opening 47 is formed in a lower portion of the housing 39 to communicate with the circulation port 31 and the inside of the housing 39. The circulation flow pipe 33 is connected to the opening 47.

The piston 41 shown in solid lines in FIG. 4 indicates its position in the treating state, while the piston 41 shown in two-dot chain lines indicates its position in the non-treating circulation state. Thus, since the forward end 43 of the piston 41 is flush with the inner wall surface of the inner tank 3 in the treating state, it does not disturb flows of the treating liquid in the inner tank 3 in the treating state.

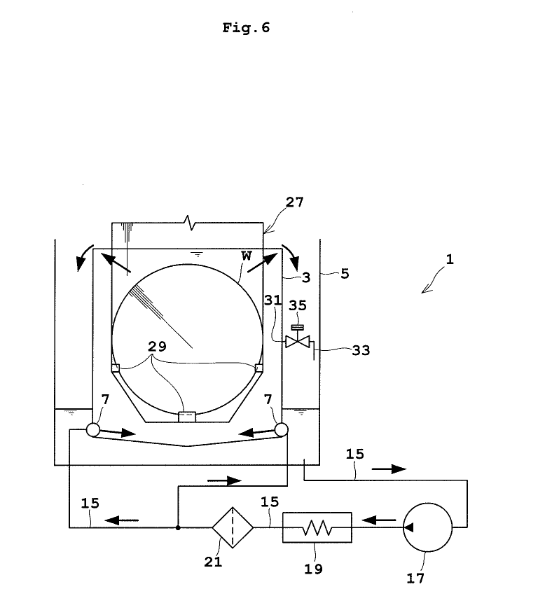

Next, treatment of the wafers W by the substrate treating apparatus 1 having the above construction will be described with reference to FIGS. 5 and 6. FIG. 5 is an explanatory view of the non-treating circulation state. FIG. 6 is an explanatory view of the treating state.

(Non-Treating Circulation State)

As shown in FIG. 5, the lifter 27 is located in the standby position above the inner tank 3, with a plurality of wafers W supported in a vertical posture by the supports 29. It is assumed that, at this time, the treating liquid is stored in the inner tank 3, outer tank 5, and circulation piping 15 in such a quantity that the treating liquid will flow over the upper edge of the inner tank 3 when the wafers W and lifter 27 move to the treating position. The controller 37 opens the switch valve 35, operates the circulating pump 17, and carries out temperature control of the treating liquid to the treatment temperature with the in-line heater 19. Although the treating liquid level in the inner tank 3 is located below the upper edge of the inner tank 3, since the switch valve 35 is opened, the treating liquid in the inner tank 3 flows into the outer tank 5 through the circulation flow pipe 33. Therefore, the treating liquid circulates through the inner tank 3, outer tank 5, and circulation piping 15 to undergo the temperature control to the treatment temperature.

The volume of the treating liquid is such that the treating liquid will overflow the inner tank 3 when the lifter 27 moves to the treating position. This volume may be determined by taking into account, the volumes of the lifter 27 and supports 29, and the volume such as corresponding to the number and thickness of wafers W. Although the volume of the lifter 27 and supports 29 is constant, there can be changes in the number of wafers W to be treated. It is therefore preferable to determine the volume of the treating liquid for allowing the treating liquid to overflow the inner tank 3, based on a total of the volume of the thinnest wafers W among the wafers W handled by this substrate treating apparatus 1 and the volumes of the lifter 27 and supports 29.

(Treating State)

When the treating liquid reaches the treatment temperature, as shown in FIG. 6, the controller 37 operates the lifter driver 30 to lower the lifter 27 along with the wafers W from the standby position to the treating position. At this time, the switch valve 35 is closed. Then, the treating liquid level in the inner tank 3 will rise by an amount corresponding to the volumes of the lifter 27, supports 29, and wafers W located inside the inner tank 3 and the treating liquid will flow over the upper edge of inner tank 3 into the outer tank 5. Therefore, the treating liquid circulates through the circulation piping 15 also in the treating state. By maintaining this state for a time specified by a recipe, the treatment according to the recipe is carried out for the plurality of wafers W.

According to this embodiment, as described above, the treating liquid is stored in the inner tank 3, outer tank 5, and circulation piping 15 in such a quantity that the treating liquid overflows the inner tank 3 into the outer tank 5 in the treating state, but does not overflow the inner tank 3 into the outer tank 5 in the non-treating state. On the other hand, in the non-treating circulation state, the switch valve 35 is opened for allowing the treating liquid to flow from the inner tank 3 to the outer tank 5 and circulate through the circulation piping 15. Therefore, the treating liquid can be circulated even in the state where the lifter 27 with the wafers W is not in the treating position, thereby to reduce the quantity of treating liquid used in treatment. As a result, an operation for temperature control or adjustment of chemical is concentration can be carried out in a short time.

Since the quantity of treating liquid decreases, the efficiency of capturing particles with the filter 21 is improved to increase an amount of particle capture per unit time.

Further, by the simple operation of opening and closing the switch valve 35, the treating liquid can be circulated even in the non-treating circulation state.

### Embodiment 2

Next, Embodiment 2 of this invention will be described with reference to the drawings.

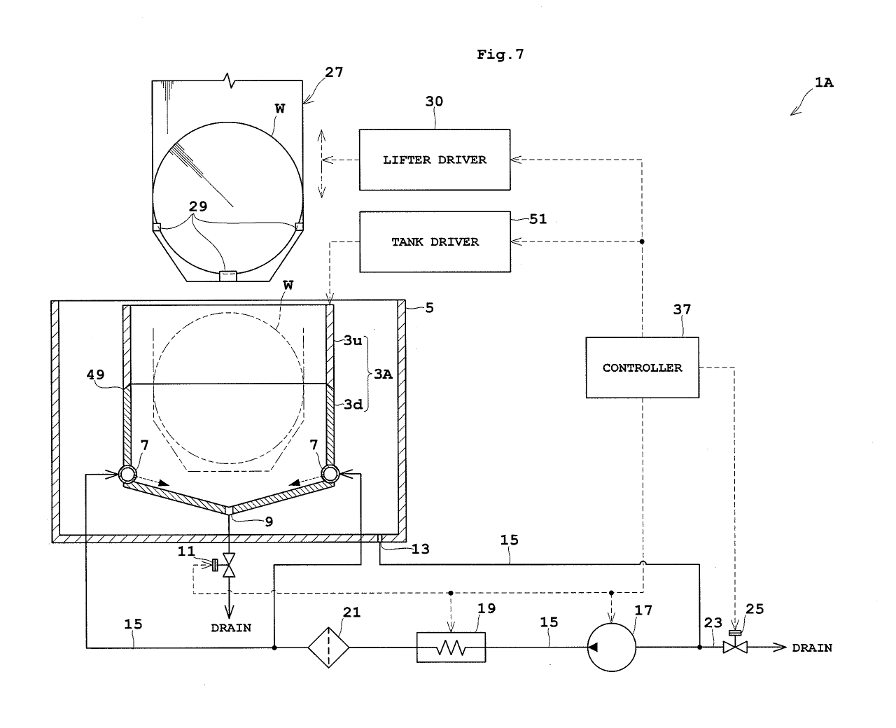

FIG. 7 is an overall view showing an outline of a substrate treating apparatus in Embodiment 2. Like reference numerals are used to identify like parts in Embodiment 1, which will not particularly be described again.

This substrate treating apparatus 1A includes an inner tank 3A greatly different in construction from the inner tank 3 in foregoing Embodiment 1. Specifically, the inner tank 3A is formed of an upper inner tank 3u including an upper edge, and a lower inner tank 3d including a bottom. The upper inner tank 3u has lower surfaces of side walls thereof forming downward-facing slopes inclined down away from the center of the inner tank 3A. The lower inner tank 3d has upper surfaces of is side walls thereof forming upward-facing slopes inclined down away from the center of the inner tank 3A, to make close contact with the downward-facing slopes of the upper inner tank 3u. The above construction provides a parting plane 49 which becomes liquid-tight when the upper inner tank 3u and lower inner tank 3d are joined at the parting plane 49.

The height position in the inner tank 3A of the parting plane 49 is the same as the height position of the circulation port 31 and switch valve 35 in foregoing Embodiment 1. In this embodiment, the upper inner tank 3u is constructed vertically movable relative to the lower inner tank 3d. Its vertical movement is carried out by a tank driver 51. The tank driver 51 is operable under control of the controller 37, as described hereinafter, to raise the upper inner tank 3u relative to the lower inner tank 3d to form a gap in the parting plane 49, and lower the upper inner tank 3u relative to the lower inner tank 3d to render the parting plane 49 liquid-tight. The tank driver 51 may raise and lower the lower inner tank 3d relative to the upper inner tank 3u, instead of raising and lowering the upper inner tank 3u.

The tank driver 51 corresponds to the “lift device” in this invention.

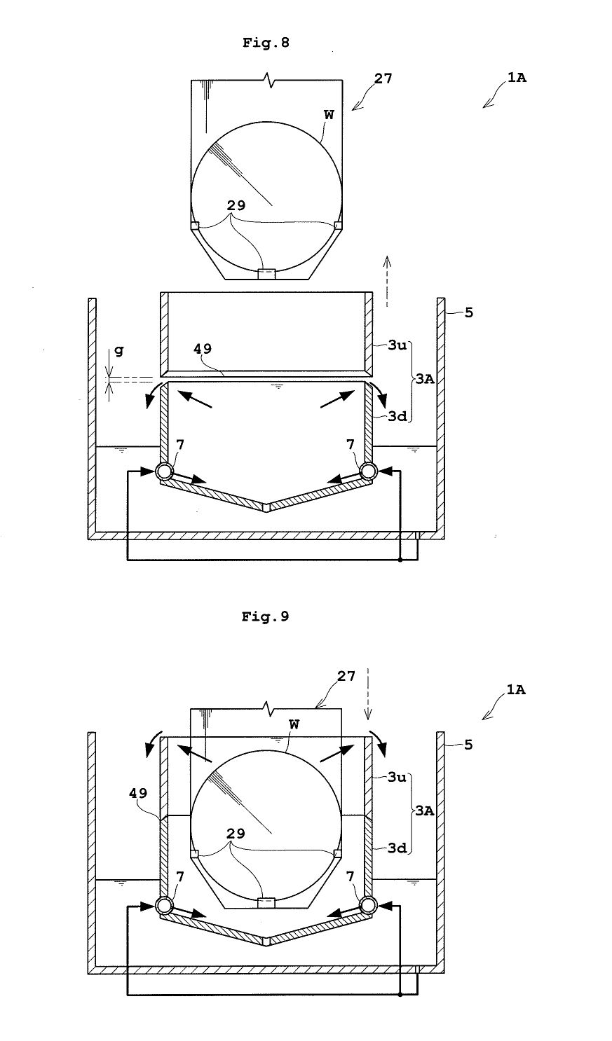

Next, operation of Embodiment 2 will be described is with reference to FIGS. 8 and 9. FIG. 8 is an explanatory view of a non-treating circulation state. FIG. 9 is an explanatory view of a treating state.

(Non-Treating Circulation State)

As shown in FIG. 8, the lifter 27 is located in the standby position, with a plurality of wafers W supported in a vertical posture by the supports 29. At this time, the treating liquid is stored in the inner tank 3A, outer tank 5, and circulation piping 15 in such a quantity that the treating liquid will flow over the upper edge of the inner tank 3A when the wafers W and lifter 27 move to the treating position. The controller 37 operates the tank driver 51 to raise the upper inner tank 3u from the lower inner tank 3d to form a gap g in the parting plane 49. Further, the controller 37 operates the circulating pump 17, and carries out temperature control of the treating liquid to the treatment temperature with the in-line heater 19. Since the gap g is formed between the upper inner tank 3u and lower inner tank 3d, the treating liquid in the lower inner tank 3d flows over an entire circumference of an upper edge of the lower inner tank 3d into the outer tank 5. Therefore, the treating liquid circulates through the inner tank 3A, outer tank 5, and circulation piping 15 to undergo the temperature control to the treatment temperature.

The volume of the treating liquid is such that the treating liquid will flow over the upper edge of the upper inner tank 3u when the lifter 27 moves to the treating position. As in Embodiment 1, this volume may be determined by taking into account the volumes of the lifter 27, supports 29, and so on.

(Treating State)

When the treating liquid reaches the treatment temperature, as shown in FIG. 9, the controller 37 operates the lifter driver 30 to lower the lifter 27 along with the wafers W from the standby position to the treating position. In advance of this, the controller 37 operates the tank driver 51 to lower the upper inner tank 3u relative to the lower inner tank 3d to render the parting plane 49 liquid-tight. Then, the treating liquid level in the inner tank 3A will rise by an amount corresponding to the volumes of the lifter 27, supports 29, and wafers W located inside the inner tank 3A, and the treating liquid will flow over the upper edge of the inner tank 3A into the outer tank 5. Therefore, the treating liquid circulates through the circulation piping 15 also in the treating state. By maintaining this state for the time specified by the recipe, treatment is carried out for the plurality of wafers W.

According to this embodiment, as described above, the inner tank 3A has a split construction including the upper inner tank 3u and lower inner tank 3d, and the treating liquid can be made to flow out over the upper edge of the lower inner tank 3d by operating the tank driver 51 to form the gap g between the upper inner tank 3u and lower inner tank 3d. Since the treating liquid can be made to flow out over the entire circumference of the upper edge of the lower inner tank 3d, the treating liquid in the inner tank 3A can flow out uniformly. As a result, the temperature control and concentration adjustment of the treating liquid can be carried out with less unevenness, and in a reduced time.

### Embodiment 3

Next, Embodiment 3 of this invention will be described with reference to the drawings.

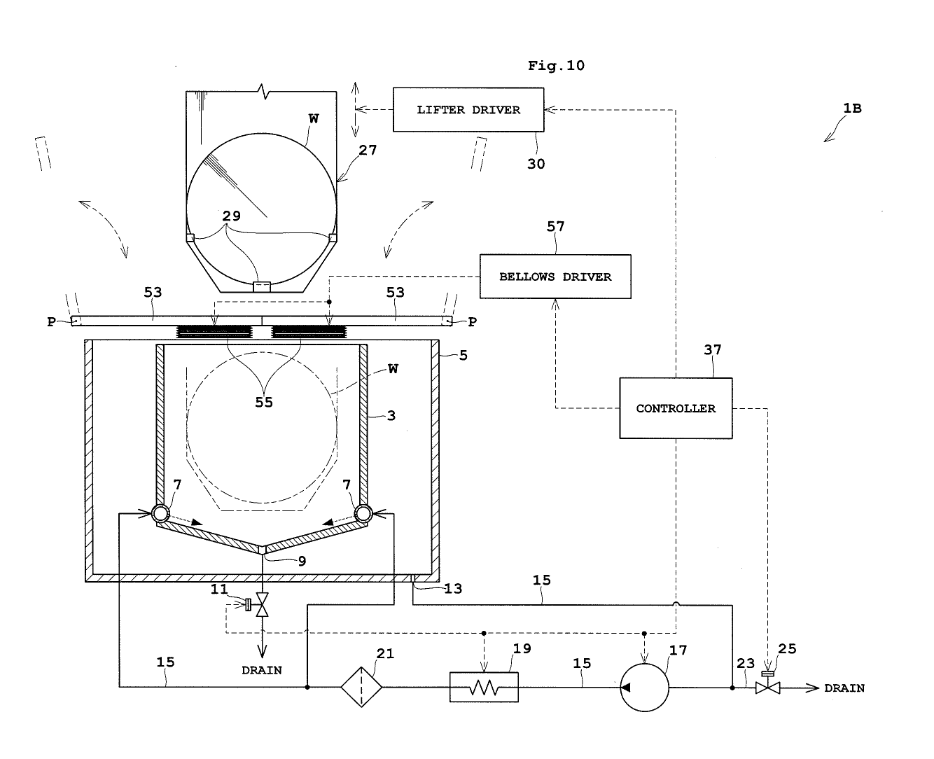

FIG. 10 is an overall view showing an outline of a substrate treating apparatus in Embodiment 3. Like reference numerals are used to identify like parts in Embodiment 1, which will not particularly be described again.

This substrate treating apparatus 1B includes a pair of auto covers 53 for covering areas above the inner tank 3 and outer tank 5. The auto covers 53 are openable upward in a double door mode. Each auto cover 53 has a pivot axis P located adjacent one of the two side walls of the outer tank 5. Opening and closing of the auto covers 53 are controlled by the controller 37.

The auto covers 53 have extendible and contractible bellows 55 attached to lower surfaces thereof and located above the inner tank 3. The bellows 55 are resistant to the treating liquid, and are expandable and contractible by supply and exhaust of a gas. On instructions from the controller 37, a bellows driver 57 supplies the gas to the bellows 55, and discharges the gas from the bellows 55. When contracted, the bellows 55 have lower ends thereof located above the treating liquid level in the inner tank 3. When extended, the bellows 55 have the lower ends located below the treating liquid level in the inner tank 3. The volume at the time of extension of the bellows 55 is set so that the treating liquid level in the inner tank 3 will rise above the upper edge of the inner tank 3.

The bellows 55 correspond to the “elastic members” in this invention. Although the elastic members are in form of the bellows 55 in this embodiment, balloon-shaped members may be used in place of the bellows 55.

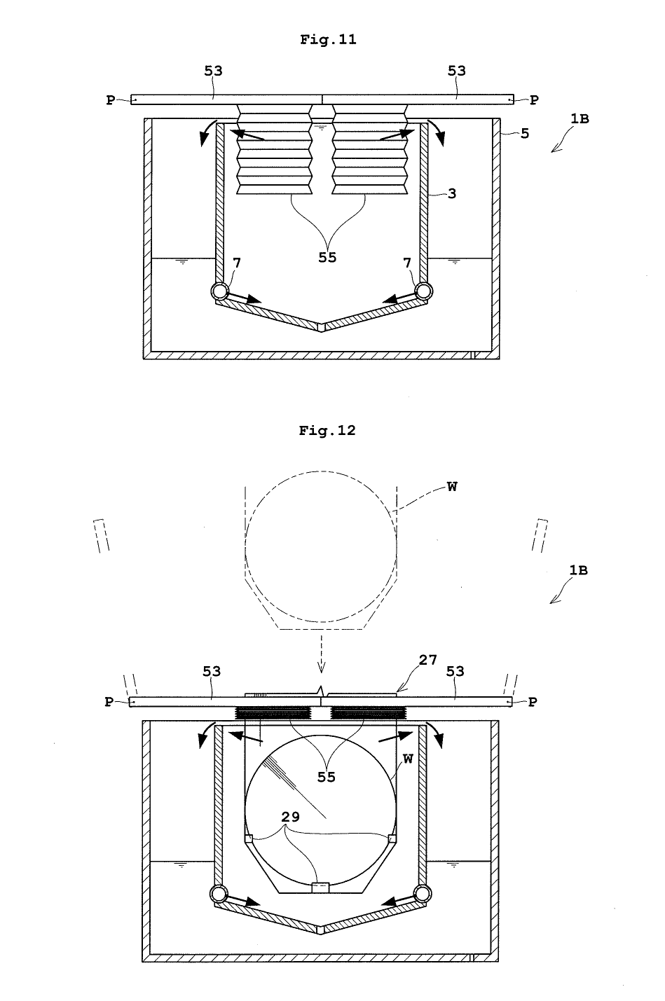

Next, operation of Embodiment 3 will be described with reference to FIGS. 11 and 12. FIG. 11 is an explanatory view of a non-treating circulation state. FIG. 12 is an explanatory view of a treating state.

(Non-Treating Circulation State)

Though not shown in FIG. 11, the lifter 27 is located in the standby position, with a plurality of wafers W supported in a vertical posture by the supports 29. At this time, the treating liquid is stored in the inner tank 3, outer tank 5, and circulation piping 15 in such a quantity that the treating liquid will flow over the upper edge of the inner tank 3 when the wafers W and lifter 27 move to the treating position. The auto covers 53 are in a closed state. The controller 37 operates the bellows driver 57 to extend the bellows 55. Further, the controller 37 operates the circulating pump 17, and carries out temperature control of the treating liquid to the treatment temperature with the in-line heater 19. Therefore, the treating liquid circulates through the inner tank 3, outer tank 5, and circulation piping 15 to undergo the temperature control to the treatment temperature.

The volume of the treating liquid is such that the treating liquid will flow over the upper edge of the inner tank 3 when the lifter 27 moves to the treating position. As in Embodiment 1, this volume may be determined by taking into account the volumes of the lifter 27, supports 29, and so on.

(Treating State)

When the treating liquid reaches the treatment temperature, the controller 37 operates the bellows driver 57 to contract the bellows 55. Then, as shown in FIG. 12, the controller 37 opens the auto covers 53 once, and operates the lifter driver 30 to lower the lifter 27 along with the wafers W from the standby position to the treating position. Subsequently, the controller 37 closes the auto covers 53. The treating liquid level in the inner tank 3 will rise by an amount corresponding to the volumes of the lifter 27, supports 29, and wafers W located inside the inner tank 3, and the treating liquid will flow over the upper edge of the inner tank 3 into the outer tank 5. Therefore, the treating liquid circulates through the circulation piping 15 in the treating state. By maintaining this state for the time specified by the recipe, treatment is carried out for the plurality of wafers W.

According to this embodiment, as described above, the bellows 55 of the auto covers 53 are extended in the non-treating circulation state. This pushes up the treating liquid level in the inner tank 3, thereby causing the treating liquid to flow from the inner tank 3 to the outer tank 5. Thus, only by extending the bellows 55, the treating liquid can be circulated.

### Embodiment 4

Next, Embodiment 4 of this invention will be described with reference to the drawings.

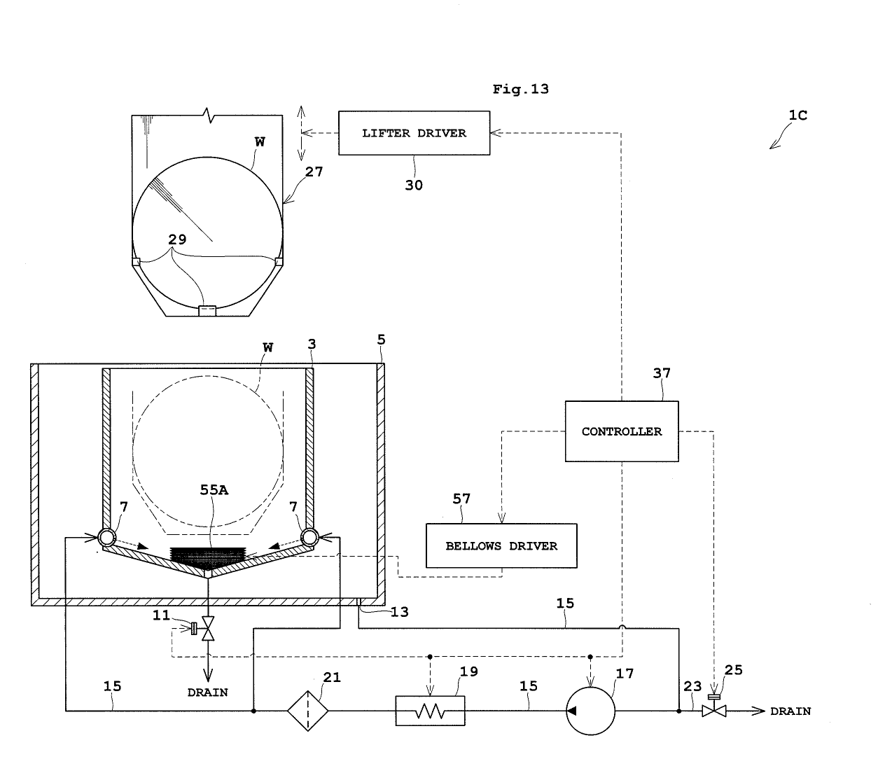

FIG. 13 is an overall view showing an outline of a substrate treating apparatus in Embodiment 4. Like reference numerals are used to identify like parts in Embodiment 1, which will not particularly be described again.

This substrate treating apparatus 1C includes an extendible and contractible bellows 55A attached to the bottom of the inner tank 3. The bellows 55A is resistant to the treating liquid, and is expandable and contractible by supply and exhaust of a gas. On instructions from the controller 37, a bellows driver 57 supplies the gas to the bellows 55A, and discharges the gas from the bellows 55A. When contracted, the bellows 55A sticks to the bottom of the inner tank 3. When extended, the bellows 55A projects toward the surface of the treating liquid in the inner tank 3. The volume at the time of extension of the bellows 55 is set so that the treating liquid level in the inner tank 3 will rise above the upper edge of the inner tank 3.

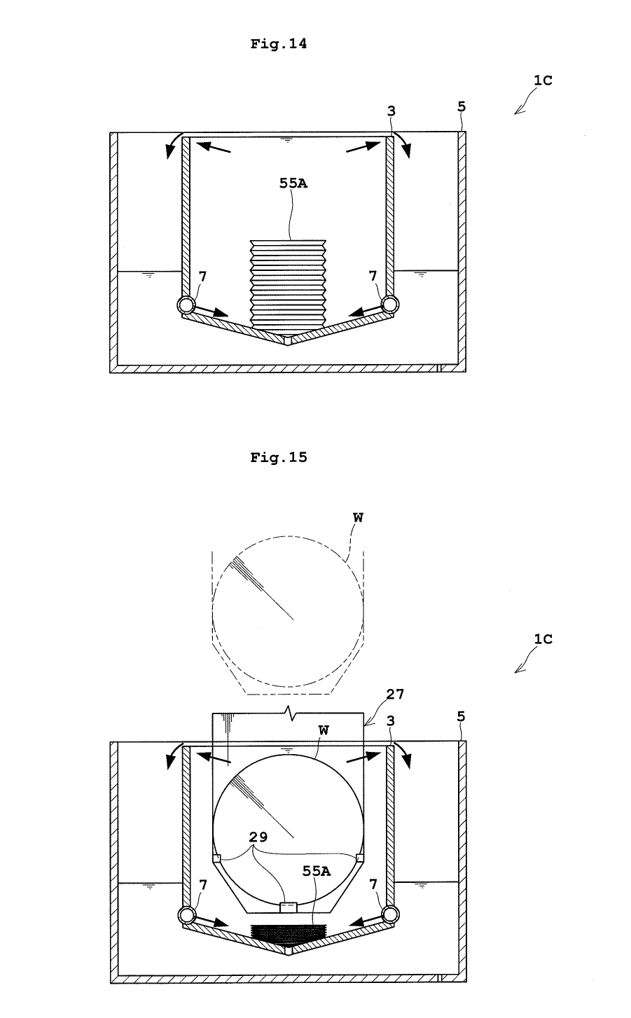

Next, operation of Embodiment 4 will be described with reference to FIGS. 14 and 15. FIG. 14 is an explanatory view of a non-treating circulation state. FIG. 15 is an explanatory view of a treating state.

(Non-Treating Circulation State)

Though not shown in FIG. 14, a plurality of wafers W supported by the lifter 27 are in the standby position. At this time, the treating liquid is stored in the inner tank 3, outer tank 5, and circulation piping 15 in such a quantity that the treating liquid will flow over the upper edge of the inner tank 3 when the wafers W and lifter 27 move to the treating position. The controller 37 operates the bellows driver 57 to extend the bellows 55A. Further, the controller 37 operates the circulating pump 17, and carries out temperature control of the treating liquid to the treatment temperature with the in-line heater 19. Therefore, the treating liquid circulates through the inner tank 3, outer tank 5, and circulation piping 15 to undergo the temperature control to the treatment temperature.

As in Embodiment 1, the volume of the treating liquid may be determined by taking into account the volumes of the lifter 27, supports 29, and so on.

(Treating state)

When the treating liquid reaches the treatment temperature, the controller 37 operates the bellows driver 57 to contract the bellows 55. Then, as shown in FIG. 15, the controller 37 moves the lifter 27 along with the wafers W to the treating position. Then, the treating liquid level in the inner tank 3 will rise by an amount corresponding to the volumes of the lifter 27, supports 29, and wafers W located inside the inner tank 3, and the treating liquid will flow over the upper edge of the inner tank 3 into the outer tank 5. Therefore, the treating liquid circulates through the circulation piping 15 in the treating state. By maintaining this state for the time specified by the recipe, treatment is carried out for the plurality of wafers W.

According to this embodiment, as described above, the bellows 55A in the bottom of the inner tank 3 is extended in the non-treating circulation state. This pushes up the treating liquid level in the inner tank 3, thereby causing the treating liquid to flow from the inner tank 3 to the outer tank 5. Thus, only by extending the bellows 55A, the treating liquid can be circulated.

### Embodiment 5

Next, Embodiment 5 of this invention will be described with reference to the drawings.

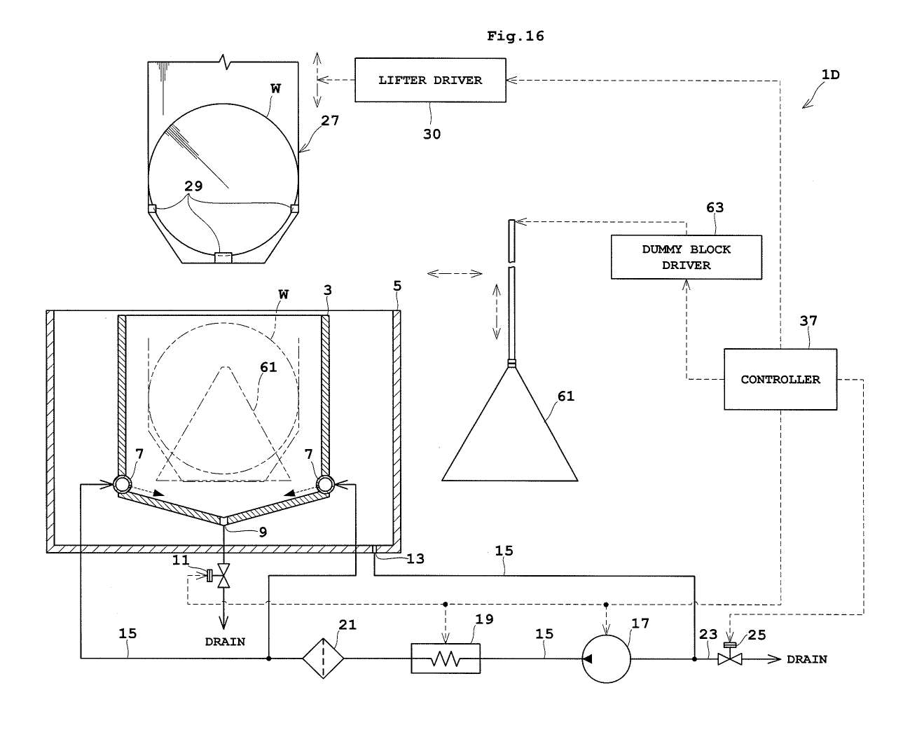

FIG. 16 is an overall view showing an outline of a substrate treating apparatus in Embodiment 5. Like reference numerals are used to identify like parts in Embodiment 1, which will not particularly be described again.

This substrate treating apparatus 1D includes a dummy block 61. The dummy block 61 is set to a volume for causing the treating liquid level in the inner tank 3 to rise above the upper edge of the inner tank 3. On instructions from the controller 37, a dummy block driver 63 moves the dummy block 61 into and out of the inner tank 3.

The substrate treating apparatus 1D has the treating liquid stored in the inner tank 3A, outer tank 5, and circulation piping 15 in such a quantity that the treating liquid will flow over the upper edge of the inner tank 3 when the wafers W and lifter 27 move to the treating position.

In the non-treating circulation state, the controller 37 operates the dummy block driver 63 to move the dummy block 61 into the inner tank 3. Then, the treating liquid level in the inner tank 3 will rise, and the treating liquid will flow over the upper edge of the inner tank 3. Further, the controller 37 operates the circulating pump 17, and carries out temperature control of the treating liquid to the treatment temperature with the in-line heater 19. Therefore, the treating liquid circulates through the inner tank 3, outer tank 5, and circulation piping 15 to undergo the temperature control to the treatment temperature.

When the treating liquid reaches the treatment temperature, the controller 37 operates the dummy block driver 63 to move the dummy block 61 out of the inner tank 3. Subsequently, in the treating state, the controller 37 operates the lifter driver 30 to lower the lifter 27 along with the wafers W from the standby position to the treating position. Then, the treating liquid level in the inner tank 3 will rise by an amount corresponding to the volumes of the lifter 27, supports 29, and wafers W located in the treating position inside the inner tank 3, and the treating liquid will flow over the upper edge of the inner tank 3 into the outer tank 5. Therefore, the treating liquid circulates through the circulation piping 15 in the treating state. By maintaining this state for the time specified by the recipe, treatment is carried out for the plurality of wafers W.

According to this embodiment, as described above, the treating liquid level in the inner tank 3 can be raised when the dummy block 61 is moved into the inner tank 3 in the non-treating circulation state. Thus, only by moving the dummy block 61, the treating liquid can be circulated.

### Embodiment 6

Next, Embodiment 6 of this invention will be described with reference to the drawings.

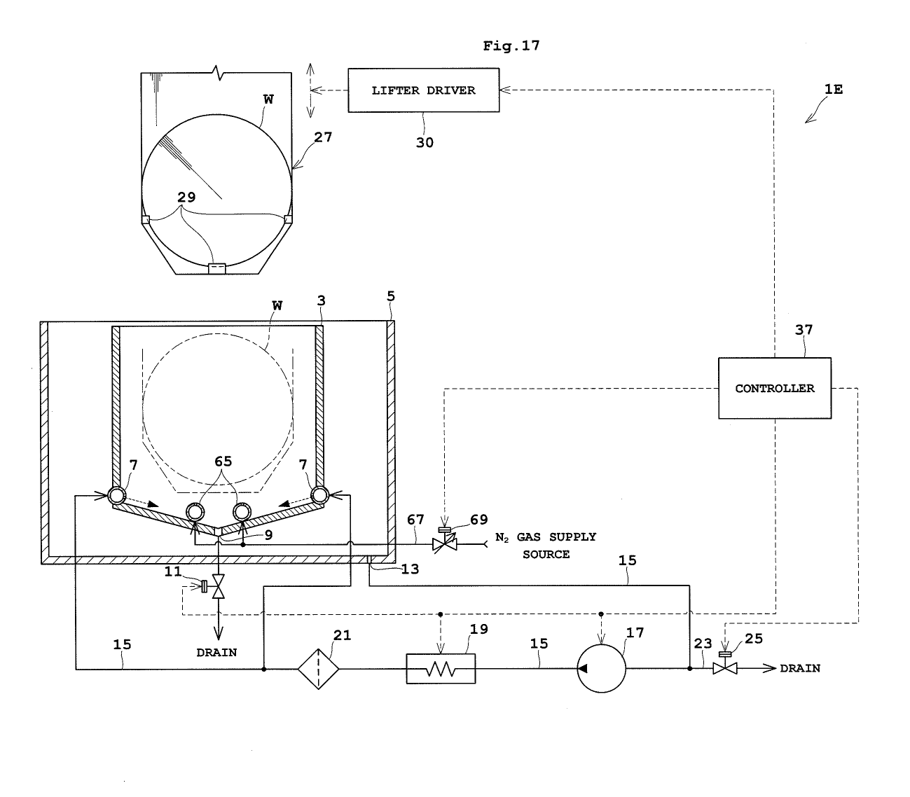

FIG. 17 is an overall view showing an outline of a substrate treating apparatus in Embodiment 6. Like reference numerals are used to identify like parts in Embodiment 1, which will not particularly be described again.

This substrate treating apparatus 1E includes two bubble feed pipes 65 arranged centrally of the bottom of the inner tank 3. These bubble feed pipes 65 feed a supplied gas as bubbles into the inner tank 3. One end of piping 67 is connected to the two bubble feed pipes 65, while the other end thereof is connected to an N₂ gas supply source. The piping 67 has a flow regulating valve 69 mounted thereon. Opening and closing of the flow regulating valve 69 and flow rate adjustment are carried out by the controller 37. The treating liquid is stored in the inner tank 3, outer tank 5, and circulation piping 15 in such a quantity that the treating liquid will not flow over the upper edge of the inner tank 3 when the wafers W and lifter 27 are in the standby position, but will flow over the upper edge of the inner tank 3 when the wafers W and lifter 27 move to the treating position.

When opening the flow regulating valve 69, the controller 37 adjusts the flow rate through the flow regulating valve 69 to generate bubbles from the bubble feed pipes 65 in a quantity for causing the treating liquid to flow over the upper edge of the inner tank 3 even though the wafers W and lifter 27 are in the standby position.

The bubble feed pipes 65 correspond to the “bubble feeding device” in this invention.

In the non-treating circulation state, the controller 37 opens the flow regulating valve 69 to generate a large quantity of bubbles from the bubble feed pipes 65. Then, the bubbles will raise the treating liquid level in the inner tank 3, whereby the treating liquid flows over the upper edge of the inner tank 3. Further, the controller 37 operates the circulating pump 17, and carries out temperature control of the treating liquid to the treatment temperature with the in-line heater 19. Therefore, the treating liquid circulates through the inner tank 3, outer tank 5, and circulation piping 15 to undergo the temperature control to the treatment temperature.

When the treating liquid reaches the treatment temperature, the controller 37 closes the flow regulating valve 69 to stop the feeding of bubbles from the bubble feed pipes 65. Subsequently, in the treating state, the controller 37 operates the lifter driver 30 to lower the lifter 27 along with the wafers W from the standby position to the treating position. Then, the treating liquid level in the inner tank 3 will rise by an amount corresponding to the volumes of the lifter 27, supports 29, and wafers W located in the treating position inside the inner tank 3, and the treating liquid will flow over the upper edge of the inner tank 3 into the outer tank 5. Therefore, the treating liquid circulates through the circulation piping 15 in the treating state. By maintaining this state for the time specified by the recipe, treatment is carried out for the plurality of wafers W.

According to this embodiment, as described above, by feeding bubbles from the bubble feed pipes 65, the treating liquid level in the inner tank 3 can be pushed up in response to the quantity of bubbles. Thus, only by generating bubbles, the treating liquid can be circulated.

Since variations of the liquid level caused by bubbles are smaller than those occurring in foregoing Embodiments 1-5, this embodiment may be combined with Embodiments 1-5 for effective use in fine adjustment of the liquid level.

Here, examples of the capacity of the inner tank 3, outer tank 5, and circulation piping 15, and the volume of the treating liquid which can be reduced by this invention will be shown for reference.

In the case of a substrate treating apparatus which can treat 50 substrates 300 mm in diameter:

tank circulating quantity (inner tank+outer tank+circulation piping) . . . 50 liters

substrates+lifter 6 liters

Thus, this invention can reduce 6 liters of the treating liquid which correspond to the total volume of the substrates and the lifter.

In the case of a substrate treating apparatus which can treat 50 substrates 450 mm in diameter:

tank circulating quantity (inner tank+outer tank+circulation piping) . . . 150 liters

substrates+lifter 20 liters

Thus, this invention can reduce 20 liters of the treating liquid which correspond to the total volume of the substrates and the lifter.

This invention is not limited to the foregoing embodiments, but may be modified as follows:

(1) In each of the foregoing embodiments, the circulation piping 15 has the in-line heater 19 and filter 21 mounted thereon. However, this invention does not necessarily need the in-line heater 19 or the filter 21. That is, the invention is applicable also to a substrate treating apparatus which circulates the treating liquid at normal temperature.

(2) In each of the foregoing embodiments, the lifter 27 holds a plurality of wafers W. Instead, the lifter 27 may hold one wafer W.

(3) Apart from the foregoing embodiments, this invention may employ a construction including non-treating circulation piping with one end thereof opening adjacent the bottom of the inner tank 3 and the other end opening to the outer tank 5, a switch valve for controlling circulation through this piping, and a pump mounted on the piping. In the non-treating circulation state, the switch valve is opened and the pump is operated is for causing the treating liquid with its level lowered in the inner tank 3 to flow out into the outer tank 5 through the non-treating circulation piping.

(4) In foregoing Embodiments 3 and 4, the bellows 55 and 55A are extended by feeding gas thereto. However, the bellows 55 and 55A may be extended using liquid.

Consequently, in Embodiment 3, the bellows 55 can be inhibited from floating to the surface of the treating liquid, thereby to prevent the auto covers 53 being opened by buoyancy.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus for treating substrates by immersing the substrates in a treating liquid, comprising:
an inner tank for storing the treating liquid;
an outer tank for collecting the treating liquid overflowing the inner tank;
a lifter movable with the substrates between a standby position above the inner tank and a treating position inside the inner tank;
circulation piping connected to the inner tank and the outer tank for circulating the treating liquid; and
a circulation control device for storing the treating liquid in the inner tank, the outer tank, and the circulation piping, in such a quantity that the treating liquid overflows the inner tank into the outer tank in a treating state in which the lifter with the substrates is located in the treating position, and remains in the inner tank without overflowing into the outer tank in a non-treating state in which the lifter with the substrates is located in the standby position, and for causing the treating liquid to flow from the inner tank to the outer tank and circulate through the circulating piping in a non-treating circulation state before the lifter moves with the substrates to the treating position.

2. The substrate treating apparatus according to claim 1, further comprising:
a switch valve disposed on a side wall of the inner tank, in a height position below an upper edge of the side wall of the inner tank;
wherein the circulation control device is arranged to open the switch valve in the non-treating circulation state, and close the switch valve in the treating state.

3. The substrate treating apparatus according to claim 2, wherein the switch valve is disposed at a liquid level in the inner tank occurring when a change is made from the treating state to the non-treating state.

4. The substrate treating apparatus according to claim 2, wherein the switch valve has a piston retractable at an opening time, and projectable at a closing time, the piston having a forward end thereof projectable to a position flush with an inner wall surface of the inner tank at the closing time.

5. The substrate treating apparatus according to claim 3, wherein the switch valve has a piston retractable at an opening time, and projectable at a closing time, the piston having a forward end thereof projectable to a position flush with an inner wall surface of the inner tank at the closing time.

6. The substrate treating apparatus according to claim 1, wherein:
the inner tank has an upper inner tank including an upper edge, and a lower inner tank including a bottom;
the apparatus further comprising a lift device for vertically moving one of the upper inner tank and the lower inner tank;
wherein the circulation control device is arranged to operate the lift device to form a gap between the upper inner tank and the lower inner tank in the non-treating circulation state, and to place the upper inner tank and the lower inner tank in close contact with each other in the treating state.

7. The substrate treating apparatus according to claim 1, further comprising:
auto covers arranged above the inner tank and the outer tank to be closed in the non-treating circulation state, and opened and closed when a change is made from the non-treating state to the treating state; and
elastic members attached to lower surfaces of the auto covers to be extendible into the treating liquid in the inner tank, and contractible upward above the treating liquid in the inner tank;
wherein the circulation control device is arranged to extend the elastic members in the non-treating circulation state, and contract the elastic members in the treating state.

8. The substrate treating apparatus according to claim 1, further comprising:
an elastic member disposed in a bottom of the inner tank to be extendible toward a surface of the treating liquid in the inner tank, and contractible to the bottom;
wherein the circulation control device is arranged to extend the elastic member in the non-treating circulation state, and contract the elastic member in the treating state.

9. The substrate treating apparatus according to claim 1, further comprising:
a dummy block movable into and out of the inner tank;
wherein the circulation control device is arranged to move the dummy block into the inner tank in the non-treating circulation state, and move the dummy block out of the inner tank in the treating state.

10. The substrate treating apparatus according to claim 1, further comprising:
a bubble feeding device for feeding bubbles into the inner tank;
wherein the circulation control device is arranged to cause the bubble feeding device to feed bubbles in the non-treating circulation state, and stop the bubble feeding device feeding the bubbles in the treating state.

11. The substrate treating apparatus according to claim 2, further comprising:
a bubble feeding device for feeding bubbles into the inner tank;
wherein the circulation control device is arranged to cause the bubble feeding device to feed bubbles in the non-treating circulation state, and stop the bubble feeding device feeding the bubbles in the treating state.

12. The substrate treating apparatus according to claim 3, further comprising:
a bubble feeding device for feeding bubbles into the inner tank;
wherein the circulation control device is arranged to cause the bubble feeding device to feed bubbles in the non-treating circulation state, and stop the bubble feeding device feeding the bubbles in the treating state.

13. The substrate treating apparatus according to claim 4, further comprising:
a bubble feeding device for feeding bubbles into the inner tank;
wherein the circulation control device is arranged to cause the bubble feeding device to feed bubbles in the non-treating circulation state, and stop the bubble feeding device feeding the bubbles in the treating state.

14. The substrate treating apparatus according to claim 5, further comprising:
a bubble feeding device for feeding bubbles into the inner tank;
wherein the circulation control device is arranged to cause the bubble feeding device to feed bubbles in the non-treating circulation state, and stop the bubble feeding device feeding the bubbles in the treating state.

15. The substrate treating apparatus according to claim 6, further comprising:
a bubble feeding device for feeding bubbles into the inner tank;
wherein the circulation control device is arranged to cause the bubble feeding device to feed bubbles in the non-treating circulation state, and stop the bubble feeding device feeding the bubbles in the treating state.

16. The substrate treating apparatus according to claim 7, further comprising:
a bubble feeding device for feeding bubbles into the inner tank;
wherein the circulation control device is arranged to cause the bubble feeding device to feed bubbles in the non-treating circulation state, and stop the bubble feeding is device feeding the bubbles in the treating state.

17. The substrate treating apparatus according to claim 8, further comprising:
a bubble feeding device for feeding bubbles into the inner tank;
wherein the circulation control device is arranged to cause the bubble feeding device to feed bubbles in the non-treating circulation state, and stop the bubble feeding device feeding the bubbles in the treating state.

18. The substrate treating apparatus according to claim 9, further comprising:
a bubble feeding device for feeding bubbles into the inner tank;
wherein the circulation control device is arranged to cause the bubble feeding device to feed bubbles in the non-treating circulation state, and stop the bubble feeding device feeding the bubbles in the treating state.

19. The substrate treating apparatus according to claim 6, wherein the upper inner tank and the lower inner tank placed in close contact with each other at a parting plane which is made liquid-tight when the upper inner tank and the lower inner tank are joined.

20. The substrate treating apparatus according to claim 9, wherein the dummy block has a volume, when moved into the inner tank, for causing a level of the treating liquid in the inner tank to rise above an upper edge of the inner tank.
